(19) United States
(12) Patent Application Publication
(10) Pub. No.: US 2026/0280717 A1
(43) Pub. Date: Sep. 17, 2026

(54) COHERENT OPTICAL RECEIVER FOR SELECTIVELY SUPPORTING SINGLE AND DUAL POLARIZATION MODE AND AN OPERATING METHOD OF THE COHERENT OPTICAL RECEIVER

(71) Applicant: ELECTRONICS AND TELECOMMUNICATIONS RESEARCH INSTITUTE, Daejeon (KR)

(72) Inventors: Jung-yeol OH, Daejeon (KR); Hun Sik KANG, Daejeon (KR)

(73) Assignee: ELECTRONICS AND TELECOMMUNICATIONS RESEARCH INSTITUTE, Daejeon (KR)

(21) Appl. No.: 19/420,213

(22) Filed: Dec. 15, 2025

(30) Foreign Application Priority Data
Mar. 11, 2025 (KR) 10-2025-0031422

(51) Int. Cl. H04B 10/61; H04B 10/2569

(52) U.S. Cl. CPC H04B 10/61; H04B 10/2569

(57) ABSTRACT

A coherent optical receiver is provided. The coherent optical receiver supports both a single-polarization mode and a dual-polarization mode, thereby providing a flexible solution in which the coherent optical receiver operates in the single-polarization mode in a P2MP environment of a coherent optical access network to reduce cost and power consumption and operates in the dual-polarization mode in a P2P environment to guarantee high-speed data transmission.

### CROSS-REFERENCE TO RELATED APPLICATIONS

This application claims the benefit of the Korean Patent Application No. 10-2025-0031422 filed on Mar. 11, 2025, which is hereby incorporated by reference as if fully set forth herein.

### BACKGROUND

### Field of the Invention

The present disclosure relates to a coherent optical receiver, and more particularly, to a coherent optical receiver that may selectively support a single-polarization mode and a dual-polarization mode to achieve high-speed data transmission, low cost, and low power consumption in an optical access network.

### Discussion of the Related Art

The coherent optical communication system provides higher channel capacity, higher spectrum efficiency, and higher receiver sensitivity than an optical communication system using intensity modulation and direct detection (IMDD). In addition, the coherent optical communication system has high frequency selectivity, which facilitates wavelength division multiplexing (WDM) implementation. Furthermore, chromatic dispersion, a dominant impairment in high-speed transmission, can be effectively compensated in the electrical domain by using digital signal processing (DSP). For these reasons, coherent technology is drawing significant attention as a core technology for next-generation optical access networks. However, a signal transmitted by a coherent optical transmitter has a polarization state that varies randomly due to birefringence occurring in an optical fiber. Accordingly, the coherent optical receiver generally employs a dual-polarization coherent receiver with polarization diversity so that a signal can be correctly received regardless of its polarization state. Nevertheless, such a dual-polarization coherent receiver requires many optical components, resulting in high cost, difficulty in integrating polarization-related elements, and increased size. To reduce this complexity of the dual-polarization coherent receiver, the polarization-time-coding (PTC) technique based on the Alamouti code has been proposed, in which two adjacent symbols are encoded to be mutually orthogonal in the time domain with respect to the X- and Y-polarization components, when generating a transmission signal with an optical transmitter. With the polarization time block coding technique, the optical receiver can be implemented as a single-polarization receiver rather than a dual-polarization receiver, thereby reducing the number of optical components compared with a conventional dual-polarization coherent receiver.

FIG. 1 is a diagram for describing a coherent optical access network structure.

Referring to FIG. 1, the coherent optical access network includes an optical line terminal (OLT) and a plurality of optical network units (ONUs). The OLT is typically located in a central office of a communication provider. The OLT and each ONU are connected through an optical fiber having a length of several tens km. An optical signal generated by the OLT is distributed to the plurality ONUs through a plurality of optical splitters (OSs). The OLT is designed to process high-performance and large-scale data in order to manage the plurality of ONUs, and it has higher cost and power consumption than the ONU. In contrast, the ONU is a network termination unit installed at a remote position, and therefore, low cost and low power consumption are needed.

Moreover, the coherent optical access network may employ a combination of a point-to-multipoint (P2MP) scheme and a point-to-point (P2P) scheme. In the P2MP scheme, because one OLT distributes an optical signal to multiple ONUs, each ONU may employ a single-polarization coherent receiver using PTC, so as to reduce cost, complexity, and power consumption. In contrast, in the P2P scheme, because a dedicated optical link is provided between the OLT and the ONU, the ONU may employ a dual-polarization coherent receiver to support high-speed data transmission.

A conventional coherent optical receiver is typically designed to support a dual-polarization mode. However, in a coherent optical access network where P2MP and P2P schemes coexist, both types of connections may be required. Therefore, when a coherent optical receiver is capable of supporting both a dual-polarization mode and a single-polarization mode, it can flexibly accommodate various operating modes according to the network environment and system requirements.

### SUMMARY

An aspect of the present disclosure is directed to providing a coherent optical receiver which is designed to select a single-polarization mode and a dual-polarization mode so as to increase the efficiency of a next-generation optical access network.

To achieve these and other advantages and in accordance with the purpose of the invention, as embodied and broadly described herein, there is provided a coherent optical receiver including: a polarization mode selector configured to selectively output an input optical signal corresponding to a transmission signal and a laser optical signal of a local oscillator in a single-polarization mode and selectively output a polarization signal of each of the input optical signal and the laser optical signal in a dual-polarization mode, based on a multiplexing operation and a polarization distribution operation; a coupler configured to couple the input optical signal to the laser optical signal to output a plurality of output optical signals in the single-polarization mode and couple the polarization signal of the input optical signal to the polarization signal of the laser optical signal to output the output optical signals having the phase difference of certain angle therebetween in the dual-polarization mode; a balanced photodetector configured to convert each of the output optical signals into an electrical analog signal; and a signal processor configured to convert the electrical analog signal into a digital signal and recover the transmission signal through signal processing on the digital signal.

In another aspect of the present invention, there is provided an operating method of a coherent optical receiver, the operating method including: a step of, by using a polarization mode selector, selectively outputting an input optical signal corresponding to a transmission signal and a laser optical signal of a local oscillator in a single-polarization mode and selectively outputting a polarization signal of each of the input optical signal and the laser optical signal in a dual-polarization mode; a step of, by using a coupler, coupling the input optical signal to the laser optical signal to output a plurality of output optical signals in the single-polarization mode and coupling the polarization signal of the input optical signal to the polarization signal of the laser optical signal to output the output optical signals in the dual-polarization mode; a step of converting each of the output optical signals into an electrical analog signal by using a balanced photodetector; and a step of, by using a signal processor, converting the electrical analog signal into a digital signal and recovering the transmission signal through signal processing on the digital signal.

According to embodiments of the present disclosure, a coherent optical receiver capable of supporting both a single-polarization mode and a dual-polarization mode may be provided. This enables a flexible solution in which the coherent receiver operates in the single-polarization mode in a P2MP environment of a coherent optical access network to reduce cost and power consumption, and operates in the dual-polarization mode in a P2P environment to ensure high-speed data transmission.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a diagram for describing a coherent optical access network structure.

FIG. 2 is a configuration diagram of a coherent optical receiver according to an embodiment of the present disclosure.

FIG. 3 is a configuration diagram of a coherent optical receiver according to another embodiment of the present disclosure.

FIG. 4 is a flowchart for describing a processing operation performed by a digital signal processor of FIGS. 2 and 3.

FIG. 5 is a diagram for describing a dual-polarization diversity coherent transmission/reception concept according to an embodiment of the present disclosure.

FIG. 6 is a diagram for describing a coherent transmission/reception concept based on polarization time coding according to an embodiment of the present disclosure.

FIG. 7 is a diagram for describing a structure of a single and dual-polarization mode coherent decoder according to an embodiment of the present disclosure.

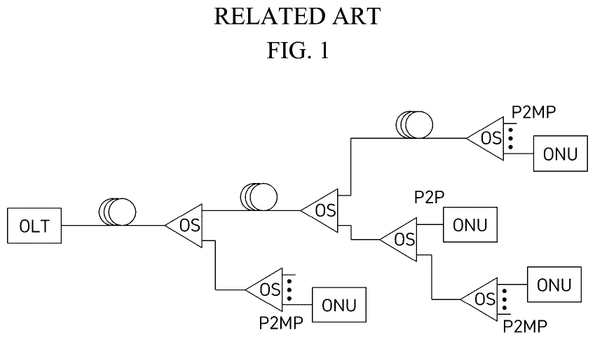

### DETAILED DESCRIPTION OF THE INVENTION

In the following description, the technical terms are used only for explaining a specific embodiment while not limiting the present disclosure. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

A coherent optical receiver according to an embodiment of the present disclosure may be designed to operate in all of a single-polarization mode and a dual-polarization mode through the selection control of the single-polarization mode and the dual-polarization mode. Hereinafter, a polarization hybrid coherent optical receiver according to an embodiment of the present disclosure will be described in detail with reference to the accompanying drawings.

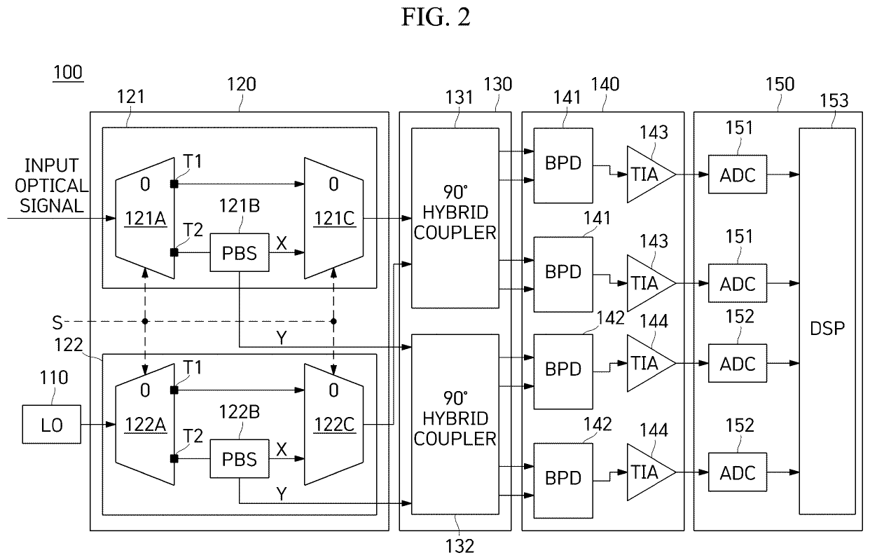

FIG. 2 is a configuration diagram of a coherent optical receiver 100 according to an embodiment of the present disclosure.

Referring to FIG. 2, the coherent optical receiver 100 according to an embodiment of the present disclosure may be configured to operate in all of the single-polarization mode and the dual-polarization mode through the selection control of the single-polarization mode and the dual-polarization mode.

To this end, the coherent optical receiver 100 may include a local oscillator (LO) 110, a polarization mode selector 120, a coupler 130, a balanced photodetector (BPD) 140, and a signal processor 150.

The local oscillator 110 may output a laser optical signal.

The polarization mode selector 120 may select the single-polarization mode or the dual-polarization mode according to a control signal S. The polarization mode selector 120 may perform a multiplexing operation and a polarization distribution operation according to the control signal S, and thus, may selectively output an input optical signal corresponding to a transmission signal and a laser optical signal of the local oscillator 110 in the single-polarization mode and may selectively output a polarization signal of each of the input optical signal and the laser optical signal in the dual-polarization mode. The polarization mode selector 120 may include a plurality of multiplexers 121A, 121C, 122A, and 122C which perform a multiplexing operation to selectively configure the single-polarization mode and the dual-polarization mode, based on the control signal S. Here, the plurality of multiplexers 121A, 121C, 122A, and 122C may be configured to perform a multiplexing operation according to the control signal S corresponding to the single-polarization mode in a point-to-multi-point (P2MP)-based optical access network environment and perform a multiplexing operation according to the control signal S corresponding to the dual-polarization mode in a point-to-point (P2P)-based optical access network environment. The plurality of multiplexers 121A, 121C, 122A, and 122C may be set to perform a multiplexing operation in one polarization mode of the single-polarization mode and the dual-polarization mode when initializing, based on a basic setting, and the one polarization mode may be changed based on a change in an optical access network environment. The control signal S may include, for example, a first control signal ‘0’ corresponding to the single-polarization mode and a second control signal ‘1’ corresponding to the dual-polarization mode. In an embodiment, the first control signal may be ‘0’, and the second control signal may be ‘1’.

The coupler 130 may couple the input optical signal to the laser optical signal to output a plurality of output optical signals in the single-polarization mode and may couple the polarization signal of the input optical signal to the polarization signal of the laser optical signal to output the output optical signals having the phase difference of certain angle therebetween in the dual-polarization mode. Here, the certain angle may be, for example, about 90 degrees. In this case, the coupler 130 may be, for example, a 90-degree hybrid coupler.

The balanced photodetector 140 may convert the output optical signals into electrical analog signals.

The signal processor 150 may convert the electrical analog signal into a digital signal and may recover the transmission signal through signal processing on the digital signal.

The polarization mode selector 120 may include, for example, a first polarization mode selector 121 and a second polarization mode selector 122.

The first polarization mode selector 121 may include, for example, a first multiplexer 121A, a polarization beam splitter (PBS) 121B, and a second multiplexer 121C. The first multiplexer 121A may output the input optical signal through an output terminal T1 thereof, based on the first control signal (for example, ‘0’) corresponding to the single-polarization mode, and may output the input optical signal through another output terminal T2 thereof, based on the second control signal (for example, ‘1’) corresponding to the dual-polarization mode. The polarization beam splitter 121B may separate the input optical signal, received from the other output terminal T2 of the first multiplexer 121A, into a horizontal polarization signal (for example, an X polarization signal) and a vertical polarization signal (for example, a Y polarization signal) and may output the vertical polarization signal to the coupler (132 of 130). The second multiplexer 121C may output the input optical signal, received from the output terminal T1 of the first multiplexer 121A, to the coupler (131 of 130) according to the first control signal (for example, ‘0’) and may output the horizontal polarization signal (for example, the X polarization signal), separated by the polarization beam splitter 121B, to the coupler (131 of 130) according to the second control signal (for example, ‘1’).

The second polarization mode selector 122 may include, for example, a first multiplexer 122A, a polarization beam splitter 122B, and a second multiplexer 122C. The first multiplexer 122A, for example, may output the laser optical signal through an output terminal T1 thereof, based on the first control signal (for example, ‘0’), and may output the laser optical signal through another output terminal T2 thereof, based on the second control signal (for example, ‘1’). The polarization beam splitter 122B, for example, may separate the laser optical signal, received from the other output terminal T2 of the first multiplexer 122A, into the horizontal polarization signal (for example, the X polarization signal) and the vertical polarization signal (for example, the Y polarization signal) and may output the vertical polarization signal (for example, the Y polarization signal) to the coupler (132 of 130). The second multiplexer 122C, for example, may output the laser optical signal, received from the output terminal T1 of the first multiplexer 122A, to the coupler (131 of 130) according to the first control signal (for example, ‘0’) and may output the horizontal polarization signal (for example, the X polarization signal), separated by the polarization beam splitter 122B, to the coupler (131 of 130) according to the second control signal (for example, ‘1’).

The coupler 130 may include, for example, a first coupler 131 and a second coupler 132. In FIG. 2, each of the first coupler 131 and the second coupler 132 is illustrated as a 90-degree hybrid coupler.

The first coupler 131, for example, may couple the input optical signal to the laser optical signal to output a plurality of output optical signals having a phase difference of a certain angle (for example, 90 degrees) therebetween in the single-polarization mode and may couple the input optical signal to a horizontal polarization signal (for example, the X polarization signal) of the laser optical signal to output the output optical signals having the phase difference of certain angle (for example, 90 degrees) therebetween in the dual-polarization mode.

The second coupler 132, for example, may couple the input optical signal to a vertical polarization signal (for example, the Y polarization signal) of the laser optical signal to output a plurality of output optical signals having the phase difference of certain angle therebetween in the dual-polarization mode. In the single-polarization mode, because there is only one polarization mode, in the present embodiment, the first coupler 131 may operate, and the second coupler 132 may not operate.

The balanced photodetector 140 may include, for example, include a first balanced photodetector 141, a second balanced photodetector 142, and a plurality of trans-impedance amplifiers (TIAs) 143 and 144. The first balanced photodetector 141 may convert output optical signals from the first coupler 131 into electrical analog signals, and the second balanced photodetector 142 may convert output optical signals from the second coupler 132 into electrical analog signals. The trans-impedance amplifiers 143 and 144 may amplify a voltage level of each of the electrical analog signals to control a signal level.

An output of the balanced photodetector 140 may include a signal corresponding to each of a real number part and an imaginary number with respect to each of two polarization components, and thus, may include four signals which include a real part Iₓ and an imaginary part Qₓ on the X polarization mode and a real part I_{y} and an imaginary part Q_{y} on the Y polarization mode.

In the single-polarization mode, because there is only one polarization mode, the second balanced photodetector 142 and the trans-impedance amplifier 144 connected to the second balanced photodetector 142 may not operate.

The signal processor 150 may include, for example, a plurality of analog-to-digital converters (ADCs) 151 and 152 and a digital signal processor (DSP) 153. The ADCs 151 and 152 may convert an electrical analog signal into a digital signal. The DSP 153 may compensate for a channel effect through a signal processing operation and may recover a transmission signal from the digital signal.

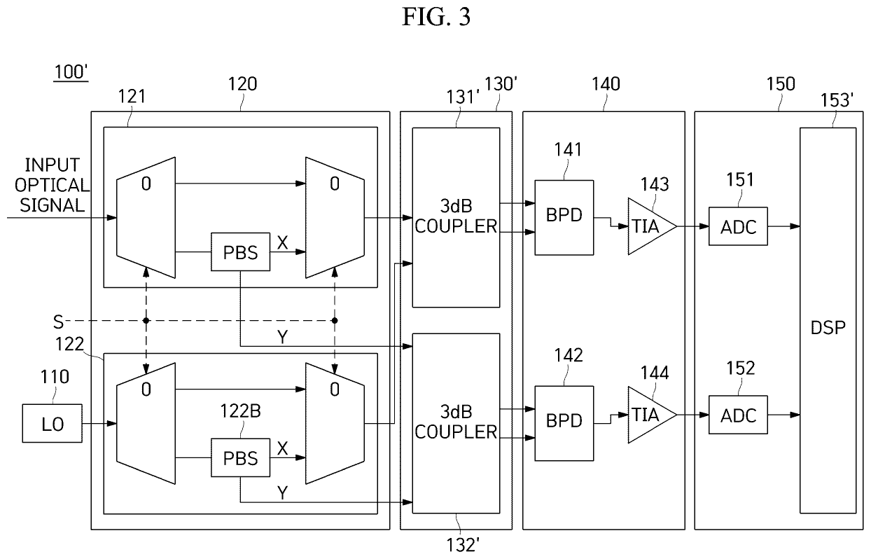

FIG. 3 is a configuration diagram of a coherent optical receiver 100′ according to another embodiment of the present disclosure.

Referring to FIG. 3, the coherent optical receiver 100′ according to another embodiment of the present disclosure may include a plurality of 3 dB couplers 131′ and 132′ having relatively low complexity, instead of the 90-degree hybrid couplers 131 and 132 of FIG. 2.

Comparing with the coherent optical receiver 100 including the 90-degree hybrid couplers 131 and 132, in the coherent optical receiver 100′ including the 3 dB couplers 131′ and 132′, the number of BPDs 141 and 142, TIAs 143 and 144, and ADCs 151 and 152 may reduce by half.

In a detection method, the coherent optical receiver 100 of FIG. 2 may be referred to as a coherent homodyne/intradyne receiver, and the coherent optical receiver 100′ of FIG. 3 may be referred to as a coherent heterodyne receiver.

The DSP 153 of the coherent homodyne/intradyne receiver may receive and process real number parts and imaginary number parts of X and Y polarization signals through four input ports thereof, and the DSP 153′ of the coherent heterodyne receiver may receive, through two input ports, the X and Y polarization signals in the form of intermediate frequency (IF) signal, and then, may decode a real number part and an imaginary number part on each polarization through digital down conversion.

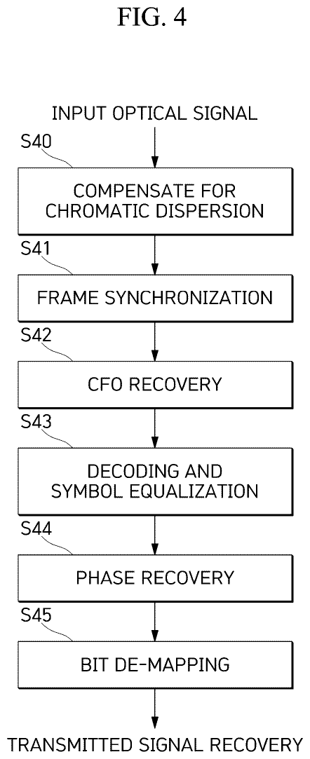

FIG. 4 is a flowchart for describing a processing operation performed by the DSP of FIGS. 2 and 3.

Referring to FIG. 4, first, in step S40, a chromatic dispersion compensation process of compensating for an adverse effect of inter-symbol interference caused by chromatic dispersion occurring in an optical fiber may be performed.

Subsequently, in step S41, a frame synchronization process of detecting a start point of a frame and compensating for a frequency offset and a phase offset based on a sampling timing may be performed.

Subsequently, in step S42, a carrier frequency offset (CFO) recover may perform a CFO recover process of compensating for an influence caused by a difference between a transmission carrier frequency and a reception carrier frequency.

Subsequently, in step S43, a decoding and symbol equalizer may perform a decoding and symbol equalization process of compensating for an influence of an optical fiber channel. Here, in the single-polarization mode, a decoding process on a polarization time coding may be added.

Subsequently, in step S44, a phase recover process of compensating for a phase effect caused by a remaining CFO and phase noise of a transmission/reception laser.

Subsequently, in step S45, a bit de-mapping process of de-mapping a recovered symbol to generate a bit sequence may be performed.

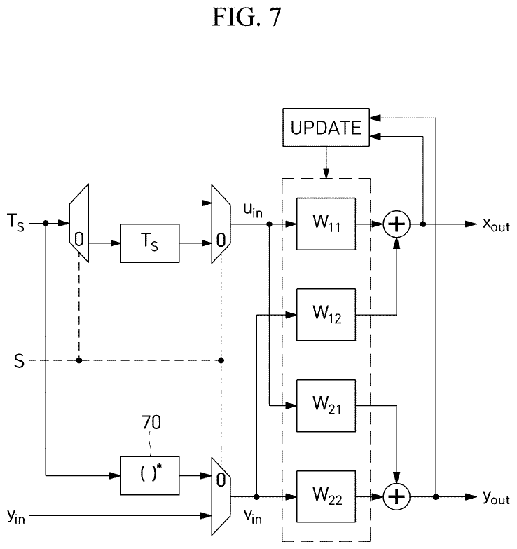

The chromatic dispersion compensation step S40, the frame synchronization step S41, the CFO recover step S42, the phase recover step S43, and the bit de-mapping step S44 may not have a difference between the single-polarization mode and the dual-polarization model in terms of a structure. On the other hand, in a signal path, there may be a difference in that the dual-polarization mode operates through two paths, and the single-polarization mode operates through one path, and it may not be difficult to control the difference. However, in the decoding and symbol equalization step S43, a DSP operation method may not largely differ between two polarization modes, and thus, a single and dual-polarization mode coherent decoder structure capable of operating in two modes may be needed. The single and dual-polarization mode coherent decoder structure for the decoding and symbol equalization step S43 will be described below with reference to FIG. 7.

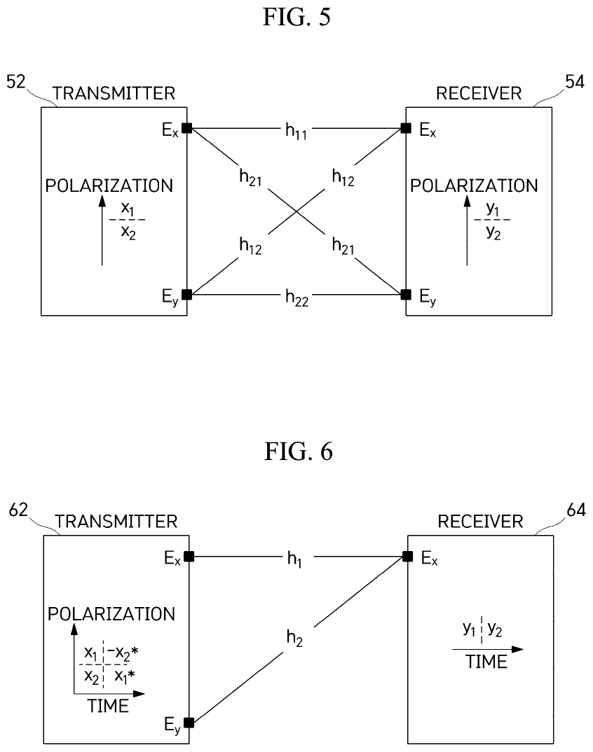

FIG. 5 is a diagram for describing a dual-polarization diversity coherent transmission/reception concept according to an embodiment of the present disclosure.

Referring to FIG. 5, a transmitter 52 may multiplex and transmit symbols x₁ and x₂ in the X polarization mode and the Y polarization mode, and a receiver 54 may receive an X polarization signal and a Y polarization signal to generate reception symbols y₁ and y₂, based on channel coefficients h₁₁, h₁₂, h₂₁, and h₂₂. The reception symbols y₁ and y₂ may be expressed as the following Equation 1.

$${y}_{1} = [ \begin{matrix}{h}_{11} & {h}_{12}\end{matrix} ] [ \begin{matrix}{x}_{1} \\ {x}_{2}\end{matrix} ] + {n}_{1} \\ {y}_{2} = [ \begin{matrix}{h}_{21} & {h}_{22}\end{matrix} ] [ \begin{matrix}{x}_{1} \\ {x}_{2}\end{matrix} ] + {n}_{2} \qquad [ Equation 1 ]$$

Here, n₁ and n₂ may each denote noise which occurs in each polarization mode. When two reception symbols are coupled with each other, this may be construed as a 2×2 multiple-input multiple-output (MIMO) system, and in such a system, a 2×2 channel matrix may be expressed as the following Equation 2.

$$[ \begin{matrix}{y}_{1} \\ {y}_{2}\end{matrix} ] = [ \begin{matrix}{h}_{11} & {h}_{12} \\ {h}_{21} & {h}_{22}\end{matrix} ] [ \begin{matrix}{x}_{1} \\ {x}_{2}\end{matrix} ] + [ \begin{matrix}{n}_{1} \\ {n}_{2}\end{matrix} ] \\ H = [ \begin{matrix}{h}_{11} & {h}_{12} \\ {h}_{21} & {h}_{22}\end{matrix} ] \qquad [ Equation 2 ]$$

When zero forcing equalization (ZFE) is applied to the reception symbol so as to recover a transmission signal, transmission symbols [symbol] and [symbol] estimated as the following Equation 3 may be calculated.

### [Equation 3]

$$[ \begin{matrix}\text{?} \\ \text{?}\end{matrix} ] = {( {H}^{H} H )}^{- 1} {H}^{H} [ \begin{matrix}{y}_{1} \\ {y}_{2}\end{matrix} ] = {( {H}^{H} H )}^{- 1} {H}^{H} ( H [ \begin{matrix}{x}_{1} \\ {x}_{2}\end{matrix} ] + [ \begin{matrix}{n}_{1} \\ {n}_{2}\end{matrix} ] ) = [ \begin{matrix}{x}_{1} \\ {x}_{2}\end{matrix} ] + {( {H}^{H} H )}^{- 1} {H}^{H} [ \begin{matrix}{n}_{1} \\ {n}_{2}\end{matrix} ]$$

FIG. 6 is a diagram for describing a coherent transmission/reception concept based on polarization time coding according to an embodiment of the present disclosure.

Referring to FIG. 6, an optical receiver 64 may use one of the X polarization mode and the Y polarization mode, and in the following description, for convenience of description, the X polarization mode will be described as an example.

Transmission signals x₁ and x₂ transmitted by a transmitter may be decoded in a polarization and time domain via the following process. In polarization time coding based on Alamouti code, in a first symbol period, a symbol x₁ may be transmitted through an X polarization channel, and a symbol x₂ may be transmitted through a Y polarization channel. In a second symbol period subsequent thereto, a symbol

$$- {x}_{2}^{*}$$

may be transmitted through an X polarization channel, and a symbol

$${x}_{1}^{*}$$

may be transmitted through a Y polarization channel. Here, * may denote a complex conjugation operation.

Two symbol pairs

$${[ {x}_{1} , {x}_{2} ]}^{T} {and [ - {x}_{2}^{*} , - {x}_{1}^{*} ]}^{T}$$

adjacent to each other may have unitary matrix properties, and thus, the optical receiver 64 may recover a symbol by using only a single-polarization signal. In addition to Alamouti code, a method similar thereto may be provided on polarization time coding of another structure for implementing a structure of a receiver in the single-polarization mode.

A transmission symbol may be input to the optical receiver 64 via an optical fiber, and in this case, when a channel coefficient on the X polarization mode is defined as h₁, and a channel coefficient on the Y polarization mode is defined as h₂, a result

$${y}_{2}^{*}$$

of a complex conjugation operation performed on a reception symbol y₁ received in a first symbol period and a reception symbol y₂ received in a second symbol period may be expressed as the following Equation 4.

$${y}_{1} = [ \begin{matrix}{h}_{1} & {h}_{2}\end{matrix} ] [ \begin{matrix}{x}_{1} \\ {x}_{2}\end{matrix} ] + {n}_{1} \\ {y}_{2}^{*} = [ \begin{matrix}{h}_{2}^{*} & - {h}_{1}^{*}\end{matrix} ] [ \begin{matrix}{x}_{1} \\ {x}_{2}\end{matrix} ] + {n}_{2}^{*} \qquad [ Equation 4 ]$$

When two reception symbols y₁ and

$${y}_{2}^{*}$$

expressed as Equation 4 are coupled to each other, this may be construed as a 2×2 MIMO system representable by the following Equation 5, and a 2×2 channel matrix in the system may be expressed as the following Equation 5.

$$[ \begin{matrix}{y}_{1} \\ {y}_{2}^{*}\end{matrix} ] = [ \begin{matrix}{h}_{1} & {h}_{2} \\ {h}_{2}^{*} & - {h}_{1}^{*}\end{matrix} ] [ \begin{matrix}{x}_{1} \\ {x}_{2}\end{matrix} ] + [ \begin{matrix}{n}_{1} \\ {n}_{2}^{*}\end{matrix} ] \\ H = [ \begin{matrix}{h}_{1} & {h}_{2} \\ {h}_{2}^{*} & - {h}_{1}^{*}\end{matrix} ] \qquad [ Equation 5 ]$$

When ZFE is applied to the reception symbol so as to recover a transmission signal, a transmission symbol expressed as the following Equation 6 may be recovered.

$$[ \begin{matrix}\text{?} \\ \text{?}\end{matrix} ] = {( {H}^{H} H )}^{- 1} {H}^{H} [ \begin{matrix}{y}_{1} \\ {y}_{2}^{*}\end{matrix} ] = {( {H}^{H} H )}^{- 1} {H}^{H} ( H [ \begin{matrix}{x}_{1} \\ {x}_{2}\end{matrix} ] + [ \begin{matrix}{n}_{1} \\ {n}_{2}^{*}\end{matrix} ] ) = [ \begin{matrix}{x}_{1} \\ {x}_{2}\end{matrix} ] + {( {H}^{H} H )}^{- 1} {H}^{H} [ \begin{matrix}{n}_{1} \\ {n}_{2}^{*}\end{matrix} ] \qquad [ Equation 6 ]$$

FIG. 7 is a diagram for describing a structure of a single and dual-polarization mode coherent decoder according to an embodiment of the present disclosure.

Referring to FIG. 7, the single and dual-polarization mode coherent decoder may perform all of a dual-polarization mode diversity coherent decoding and polarization time coding coherent decoding.

A single-polarization mode operation or a dual-polarization mode operation may be selected based on the control signal S. For example, when the control signal S is ‘0’, the single-polarization mode may be selected, and an X polarization complex input signal Xᵢₙ consisting of a real number part and an imaginary number part (i.e., a complex number) may be delayed for a time corresponding to one symbol Tₛ, and then, may be input as Uᵢₙ. Simultaneously, a complex conjugation operation 70 on the X polarization complex input signal Xᵢₙ may be performed, and an operation result thereof may be input as Vᵢₙ. When the control signal S is ‘1’, the dual-polarization mode may be selected, the X polarization complex input signal Xᵢₙ may be input as Uᵢₙ, and the dual-polarization mode may be selected, a Y polarization complex input signal Yᵢₙ may be input as Vᵢₙ.

The single and dual-polarization mode coherent decoder may be configured to include a multi-tap adaptive finite impulse response (FIR) filter W₁₁, W₁₂, W₂₁, and W₂₂.

Various equalization algorithms such as a constant modulus algorithm (CMA), a least mean square (LMS), and a radius directed equalizer (RDE) may be used for updating a channel coefficient of a multi-tap adaptive FIR filter.

For example, channel coefficient update based on CMA may be expressed as the following Equation 7.

$${w}_{11} ← {w}_{11} + {μ}_{f} {ε}_{x} {u}_{in}^{*} {x}_{out} \\ {w}_{12} ← {w}_{12} + {μ}_{f} {ε}_{x} {v}_{in}^{*} {x}_{out} \\ {w}_{21} ← {w}_{21} + {μ}_{f} {ε}_{y} {u}_{in}^{*} {y}_{out} \\ {w}_{22} ← {w}_{22} + {μ}_{f} {ε}_{y} {v}_{in}^{*} {y}_{out} \qquad [ Equation 7 ]$$

Here, μ_{f} may denote an update convergence coefficient of a filter, and an error signal may be expressed as the following Equation 8.

$${ε}_{x} = 1 - {\vert {x}_{out} \vert}^{2} \\ {ε}_{y} = 1 - {\vert {y}_{out} \vert}^{2} \qquad [ Equation 8 ]$$

Channel coefficient update based on LMS may be expressed as the following Equation 9.

$${w}_{11} ← {w}_{11} + {μ}_{f} {ε}_{x} {u}_{in}^{*} \\ {w}_{12} ← {w}_{12} + {μ}_{f} {ε}_{x} {v}_{in}^{*} \\ {w}_{21} ← {w}_{21} + {μ}_{f} {ε}_{y} {u}_{in}^{*} \\ {w}_{22} ← {w}_{22} + {μ}_{f} {ε}_{y} {v}_{in}^{*} \qquad [ Equation 9 ]$$

An error signal may be expressed as the following Equation 10.

$${ε}_{x} = {d}_{x} - {x}_{out} \\ {ε}_{y} = {d}_{y} - {y}_{out} \qquad [ Equation 10 ]$$

Here, dₓ and d_{y} may respectively denote a symbol which is determined by an initial training symbol and a symbol which is recovered in a stabilized state subsequently.

Implementations of various technologies described herein may be implemented with a digital electronic circuitry, computer hardware, firmware, software, or a combination thereof. The implementations may be implemented as a computer program product (i.e., an information carrier (for example, a machine-readable storage device (computer-readable media) or a computer program typically embodied in a propagation signal), for processing by an operation of a data processing device (for example, a programmable processor, a computer, or a plurality of computers) or controlling the operation. A computer program such as the computer program(s) described above may be recorded in a programming language of an arbitrary type including compiled or interpreted languages and may be an independent program, or may be provided as an arbitrary type including a module, a component, a subroutine, or another unit appropriate for use in a computing environment. The computer program may be provided to be processed in one computer or a plurality of computers in one site or to be distributed all over a plurality of sites and connected to each other by a communication network.

Processors appropriate for processing of a computer program may include, for example, all of general-use and special-purpose microprocessors and one or more arbitrary processors of an arbitrary kind of digital computer. Generally, a processor may receive instructions and data from read only memory or random access memory or both thereof. Elements of a computer may include at least one processor executing instructions and one or more memory devices storing the instructions and the data. Generally, a computer may include one or more large-scale storage devices (for example, magnetic disks, magneto-optical disks, or optical disks) storing data, or may be coupled to receive data therefrom or transfer data thereto or transfer and receive data to and from both thereof. Information carriers appropriate for embodying computer program instructions and data may include, for example, semiconductor memory devices (for example, a hard disk, magnetic media such as a floppy disk and a magnetic tape, compact disk read only memory (CD-ROM), optical media such as a digital video disk (DVD), magneto-optical media such as a floptical disk, read only memory (ROM), random access memory (RAM), flash memory, erasable programmable ROM (EPROM), and electrically erasable programmable ROM (EEPROM)). A processor and a memory may be complemented by a special-purpose logic circuitry, or may be included therein.

According to embodiments of the present disclosure, a coherent optical receiver for supporting all of a single-polarization mode and a dual-polarization mode may be provided, thereby providing a flexible solution where the coherent optical receiver operates in the single-polarization mode in a P2MP environment of a coherent optical access network to reduce cost and power consumption and operates in the dual-polarization mode in a P2P environment to guarantee high-speed data transmission.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A coherent optical receiver comprising:
a polarization mode selector configured to selectively output an input optical signal corresponding to a transmission signal and a laser optical signal of a local oscillator in a single-polarization mode and selectively output a polarization signal of each of the input optical signal and the laser optical signal in a dual-polarization mode, based on a multiplexing operation and a polarization distribution operation;
a coupler configured to couple the input optical signal to the laser optical signal to output a plurality of output optical signals in the single-polarization mode and couple the polarization signal of the input optical signal to the polarization signal of the laser optical signal to output the output optical signals having the phase difference of certain angle therebetween in the dual-polarization mode;
a balanced photodetector configured to convert each of the output optical signals into an electrical analog signal; and
a signal processor configured to convert the electrical analog signal into a digital signal and recover the transmission signal through signal processing on the digital signal.

2. The coherent optical receiver of claim 1, wherein the polarization mode selector comprises a plurality of multiplexers configured to perform a multiplexing operation according to a control signal for selecting the single-polarization mode and the dual-polarization mode.

3. The coherent optical receiver of claim 2, wherein the plurality of multiplexers are configured to perform a multiplexing operation according to the control signal corresponding to the single-polarization mode in a point-to-multi-point (P2MP)-based optical access network environment and perform a multiplexing operation according to the control signal corresponding to the dual-polarization mode in a point-to-point (P2P)-based optical access network environment.

4. The coherent optical receiver of claim 2, wherein the plurality of multiplexers are configured to perform a multiplexing operation in one polarization mode of the single-polarization mode and the dual-polarization mode when initializing, based on a basic setting, and the one polarization mode is changed based on a change in an optical access network environment.

5. The coherent optical receiver of claim 1, wherein the polarization mode selector comprises:
a first polarization mode selector configured to receive the input optical signal, output the input optical signal according to a first control signal corresponding to the single-polarization mode, and output a horizontal polarization signal and a vertical polarization signal of the input optical signal according to a second control signal corresponding to the dual-polarization mode; and
a second polarization mode selector configured to receive the laser optical signal, output the laser optical signal according to the first control signal, and output a horizontal polarization signal and a vertical polarization signal of the laser optical signal according to the second control signal.

6. The coherent optical receiver of claim 5, wherein the first polarization mode selector comprises:
a first multiplexer configured to output the input optical signal through an output terminal thereof according to the first control signal and output the input optical signal through another output terminal thereof according to the second control signal;
a polarization beam splitter configured to separate the input optical signal, received through the other output terminal of the first multiplexer, into a horizontal polarization signal and a vertical polarization signal and output the vertical polarization signal to the coupler; and
a second multiplexer configured to output the input optical signal, received through the output terminal of the first multiplexer, to the coupler according to the first control signal and output the horizontal polarization signal, separated by the polarization beam splitter, to the coupler according to the second control signal.

7. The coherent optical receiver of claim 5, wherein the second polarization mode selector comprises:
a first multiplexer configured to output the laser optical signal through an output terminal thereof according to the first control signal and output the laser optical signal through another output terminal thereof according to the second control signal;
a polarization beam splitter configured to separate the laser optical signal, received through the other output terminal of the first multiplexer, into a horizontal polarization signal and a vertical polarization signal and output the vertical polarization signal to the coupler; and
a second multiplexer configured to output the laser optical signal, received through the output terminal of the first multiplexer, to the coupler according to the first control signal and output the horizontal polarization signal, separated by the polarization beam splitter, to the coupler according to the second control signal.

8. The coherent optical receiver of claim 1, wherein the coupler comprises:
a first coupler configured to couple the input optical signal to the laser optical signal to output a plurality of output optical signals in the single-polarization mode and couple the input optical signal to a horizontal polarization signal of the laser optical signal to output the output optical signals having the phase difference of certain angle therebetween in the dual-polarization mode; and
a second coupler configured to couple the input optical signal to a vertical polarization signal of the laser optical signal to output the output optical signals having the phase difference of certain angle therebetween.

9. The coherent optical receiver of claim 1, wherein the coupler is a 90-degree hybrid coupler.

10. The coherent optical receiver of claim 1, wherein the coupler is a 3 dB coupler.

11. An operating method of a coherent optical receiver, the operating method comprising:
a step of, by using a polarization mode selector, selectively outputting an input optical signal corresponding to a transmission signal and a laser optical signal of a local oscillator in a single-polarization mode and selectively outputting a polarization signal of each of the input optical signal and the laser optical signal in a dual-polarization mode;
a step of, by using a coupler, coupling the input optical signal to the laser optical signal to output a plurality of output optical signals in the single-polarization mode and coupling the polarization signal of the input optical signal to the polarization signal of the laser optical signal to output the output optical signals having the phase difference of certain angle therebetween in the dual-polarization mode;
a step of converting each of the output optical signals into an electrical analog signal by using a balanced photodetector; and
a step of, by using a signal processor, converting the electrical analog signal into a digital signal and recovering the transmission signal through signal processing on the digital signal.

12. The operating method of claim 11, wherein the step of selectively outputting the input optical signal comprises a step of performing a multiplexing operation according to a control signal for selecting the single-polarization mode and the dual-polarization mode by using a plurality of multiplexers included in the polarization mode selector.

13. The operating method of claim 11, wherein the step of selectively outputting the input optical signal comprises:
a step of performing a multiplexing operation according to the control signal corresponding to the single-polarization mode in a point-to-multi-point (P2MP)-based optical access network environment by using the plurality of multiplexers included in the polarization mode selector; and
a step of performing a multiplexing operation according to the control signal corresponding to the dual-polarization mode in a point-to-point (P2P)-based optical access network environment by using the plurality of multiplexers included in the polarization mode selector.

14. The operating method of claim 11, wherein the step of selectively outputting the input optical signal comprises:
a step of, by using a first polarization mode selector of the polarization mode selector, outputting the input optical signal according to a first control signal corresponding to the single-polarization mode and outputting a horizontal polarization signal and a vertical polarization signal of the input optical signal according to a second control signal corresponding to the dual-polarization mode; and
a step of, by using a second polarization mode selector of the polarization mode selector, outputting the laser optical signal according to the first control signal and outputting a horizontal polarization signal and a vertical polarization signal of the laser optical signal according to the second control signal.
